(19) United States
(12) Patent Application Publication
(10) Pub. No.: US 2011/0187203 A1
(43) Pub. Date: Aug. 4, 2011

(54) POWER CONTROL DEVICE, ELECTRONIC APPARATUS, AND POWER CONTROL METHOD

(75) Inventor: Katsuya OHNO, Tokyo (JP)

(73) Assignee: KABUSHIKI KAISHA TOSHIBA, Tokyo (JP)

(21) Appl. No.: 12/955,733

(22) Filed: Nov. 29, 2010

(30) Foreign Application Priority Data
Jan. 29, 2010 (JP) 2010-019696

(51) Int. Cl. H02J 1/00

(52) U.S. Cl. 307/126

(57) ABSTRACT

A power control device includes: a controller configured to switch on or off a power supplied to other components; a monitoring module configured to monitor an on/off state of power that is switched by the controller; and a comparing module configured to compare a control state of power switched by the controller and a supply state monitored by the monitoring module, wherein the controller is configured to control the power so as to equalize the control state and the supply state when a comparison result of the comparing module shows that the control state and the supply state are different from each other.

### CROSS-REFERENCE TO THE RELATED APPLICATION(S)

The present application is based upon and claims priority from prior Japanese Patent Application No. 2010-019696, filed on Jan. 29, 2010, the entire contents of which are incorporated herein by reference.

### FIELD

Embodiments described herein generally relate to a power control device, an electronic apparatus, and a power control method for controlling the supply of power to reduce a power consumption.

### BACKGROUND

In recent years, electronic apparatus have spread widely which have an operating state in which almost all functional sections of the apparatus are operative and a standby state in which main functional sections are inoperative and only restricted operations such as timekeeping and an operation of responding to a particular command input from a remote controller or the like are enabled. In general, a control is made so that the supply of power to particular components is on in the operating state and is off in the standby state.

In many cases, the switching between the on and off states of the supply of supply power is realized by on/off-switching a relay contact provided in a power supply path in response to a command input from the user of the apparatus or using a timer for starting or stopping a particular operation. However, where a latching relay is used for such switching, the contact inside the relay may be switched on to off or off to on unintentionally due to vibration or the like. That is, there may occur a contradiction between the relay control state of a control circuit and the actual on/off state of the relay contact.

In the above circumstances, it is desired that the supply power on/off control which is indispensable for a normal system operation of the apparatus be increased in stability.

For example, JP-A-2000-047764 discloses a technique of notifying the outside of the abnormality by flashing an LED in a particular pattern when an abnormality is found in the output voltage of a main power unit and a main power switch being on is detected or when an abnormality is found in the output voltage of a TV power unit and a TV power switch being on is detected.

JP-A-2002-318624 discloses a technique that a microcomputer stops the supply of power to an additional circuit by turning off a relay switch via which power is supplied to a main power unit if an abnormality detecting circuit detects an abnormal state while the power is on.

However, the technique described in JP-A-2000-047764 is such that occurrence of the abnormality is announced using the LED when an abnormality is detected in the output voltage of the power unit while a control is being made to keep the power on.

The technique of JP-A-2002-318624 is such that the supply of power from the power unit is stopped by making a power-off control if an abnormality is detected in the output voltage of the power unit while a control is being made to keep the power on.

That is, the conventional techniques only intend to protect the components that are supplied with power (in particular, the supply of power is stopped when a voltage abnormality occurs in a supply power on state) and do not address increase of the stability of a supply power on/off switching control.

### BRIEF DESCRIPTION OF THE DRAWINGS

A general configuration that implements the various features of the present invention will be described with reference to the drawings. The drawings and the associated descriptions are provided to illustrate embodiments of the invention and not to limit the scope of the invention.

FIG. 1 is a module diagram showing a configuration of a TV receiver which is equipped with a power control device according to an embodiment of the present invention.

FIG. 2 is a system configuration diagram of components which perform power control processing and state monitoring control according to the embodiment.

FIG. 3 is a flowchart showing how the power control processing and the state monitoring processing are performed in a composite manner.

FIG. 4 is a system configuration diagram of components which perform modified versions of the power control processing and the state monitoring processing that are performed by the components shown in FIG. 2.

### DETAILED DESCRIPTION

According to the embodiments described herein, there is provided a power control device including: a controller configured to switch on or off a power supplied to other components; a monitoring module configured to monitor an on/off state of power that is switched by the controller; and a comparing module configured to compare a control state of power switched by the controller and a supply state monitored by the monitoring module, wherein the controller is configured to control the power so as to equalize the control state and the supply state when a comparison result of the comparing module shows that the control state and the supply state are different from each other.

Embodiments according to the present invention will be described in detail with reference to the accompanying drawings. The scope of the claimed invention should not be limited to the examples illustrated in the drawings and those described in below.

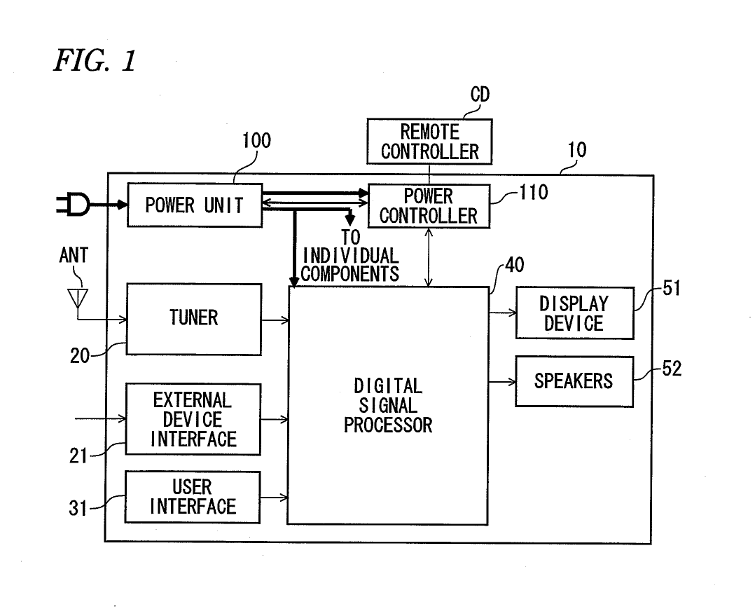

FIG. 1 is a module diagram showing a configuration of a TV receiver 10 which is equipped with a power control device according to the embodiment of the invention. The TV receiver 10 according to the embodiment is an electronic apparatus that is supplied with supply power that is controlled by the power control device.

The TV receiver 10 according to the embodiment includes a tuner 20, an external device interface 21, a user interface 31, a digital signal processor 40, a display device 51, speakers 52, a power unit 100, and a power controller 110. An antenna ANT is connected to the tuner 20, and the power unit 100 is connected to an indoor outlet or the like. The power controller 110 exchanges information with a remote controller CD and functions as the power control device according to the embodiment. The remote controller CD is a remote control device such as an infrared remote controller or a radio communication device and is equipped with an operation key (not shown) for on/off-switching the power of the TV receiver 10.

The TV receiver 10 performs various processing by operating on external power that is supplied from an indoor outlet or the like that is connected to the power unit 100. More specifically, in the TV receiver 10, the supply of supply power to almost all components of the TV receiver 10 is on/off-switched according to information that is transmitted from the remote controller CD and is to be used for on/off-switching the power of the TV receiver 10. The supply of supply power is also on/off-switched with predetermined timing. Furthermore, the actual on/off state of the supply of supply power that has been switched is monitored.

The power unit 100 generates supply power having a predetermined voltage by performing power conversion processing such as AC/DC conversion and DC/DC conversion on external power that is supplied from an indoor outlet or the like. Furthermore, the power unit 100 generates battery power by performing charging processing of charging a particular battery using the supply power. The power unit 100 on/off-switches the supply of supply power according to a control signal that is input from the power controller 110 and is to be used for on/off-switching the supply of supply power. While the supply of supply power is on, the supply power is supplied to almost all components of the TV receiver 10 including the digital signal processor 40. Battery power is supplied to the power controller 110 while the supply of supply power is off.

The power controller 110 outputs, to the digital signal processor 40, commands that reflects information transmitted from the remote controller CD. The power controller 110 outputs, to the power unit 100, a control signal for on/off-switching the supply of supply power according to information transmitted from the remote controller CD or with predetermined timing. The power controller 110 operates on battery power supplied from the power unit 100 while the supply of supply power is off, and operates on supply power that is supplied from the power unit 100 while the supply of supply power is on. Furthermore, the power controller 110 monitors the actual on/off state of the supply of supply power from the power unit 100.

That is, in the TV receiver 10 according to the embodiment, when the power unit 100 has turned on the supply of supply power, an ordinary operation mode is established in which almost all components to be described below are supplied with supply power. When the power unit 100 has turned off the supply of supply power, a standby mode is established in which almost all of the components to be described below are not supplied with supply power and rendered inoperative. Therefore, it can be said that the above-mentioned information that is transmitted from the remote controller CD and is to be used for on/off switching the power of the TV receiver 10 is information for switching between the ordinary operation mode and the standby mode of the TV receiver 10.

The tuner 20 has tuners and demodulators for processing terrestrial or satellite digital or analog broadcast waves received by the antenna ANT. The tuner 20 receives reception signals of the antenna ANT and performs processing of tuning in to a reception signal on a particular channel, demodulation processing, etc. The tuner 20 outputs, to the digital signal processor 40, a transport stream signal (hereinafter referred to as a TS signal) that is obtained by the above pieces of processing and contains audio-video information of a program and program-related information such as a program name.

The external device interface 21 has information extracting modules for extracting information according to various standards such as the HDMI (registered trademark) standard, the USB standard, and the IEEE 1394 standard. The external device interface 21 receives information containing audio-video information of a content and content-related information such as a content name from any of information providing sources such as external apparatus and storage media (e.g., external HDD and memory card) that are connected to connection terminals that comply with the above various standards, and outputs a TS signal corresponding to the received information to the digital signal processor 40.

The user interface 31 has operation keys for receiving a command input for operating the TV receiver 10 and outputs command corresponding to a operation on each operation key.

The digital signal processor 40 performs plural kinds of processing using components provided in itself or connected to it. For example, the digital signal processor 40 performs input selection processing of selecting a TS signal input source from input sources such as the tuner 20 and the external device interface 21 according to command that is supplied from the user interface 31 or received from the remote controller CD via the power controller 110. The digital signal processor 40 performs predetermined processing on a TS signal that is input from the selected input source and outputs a resulting video signal and audio signal to the display device 51 and the speakers 52, respectively.

In the embodiment, when receiving, from the power controller 110, information as an instruction to turn off the supply of supply power, the digital signal processor 40 performs predetermined processing of switching the operation state of the TV receiver 10 from the ordinary operation mode to the standby mode. The digital signal processor 40 operates on the supply power that is supplied from the power unit 100.

The display device 51 is a display module which includes a display panel for displaying an image contained in a video signal that is input from the digital signal processor 40. The display device 51 may be a flat panel display such as an LCD (liquid crystal display) or a PDP (plasma display panel).

The speakers 52 output audio in accordance with an audio signal that is input from the digital signal processor 40. The speakers 52 may consist of two speakers (left-channel and right-channel speakers) and, if necessary, a subwoofer for outputting a low-frequency part of an input audio signal.

In addition to the above-described components, the TV receiver 10 may be equipped with a module (not shown) for implementing a network communication function that has a communication processor for performing a communication over a network such as a LAN or a WAN. This module receives information containing an audio-video information of a content and content-related information from an information providing source such as a particular server or a recording medium located on the other side of a connected network, and outputs a TS signal that is based on the received information to the digital signal processor 40. The digital signal processor 40 can select a TS signal that is input from this module as one input source.

The embodiment is directed to the TV receiver 10 as an electronic apparatus according to the invention. However, the invention may be applied to other electronic apparatus such as a personal computer, a portable mobile terminal device, and an HDD/optical disc recorder. The invention may also be applied to a set-top box or the like which receives not only terrestrial broadcasts and satellite broadcasts but also radio broadcasts and cable broadcasts transmitted over the Internet, a cable network, or the like. Furthermore, the invention may be applied to a power control device such as power adaptors for supplying supply power to various electronic apparatus.

The above-configured plural components of the TV receiver 10 according to the embodiment of the invention perform plural kinds processing by operating on the supply power or battery power that is supplied from the power unit 100. In particular, the power controller 110 performs power control processing of controlling the power unit 100 so as to on/off-switching the supply of supply power to almost all of the components of the TV receiver 10. The power controller 110 also performs state monitoring processing of monitoring the actual on/off state of the supply of supply power that has been switched by the power unit 100. As such, the TV receiver 10 according to the embodiment of the invention can increase the stability of the supply power on/off switching control. That is, the above plural kinds of processing, which are directed to the control of supply power that is supplied from the power unit 100, are performed in a composite manner mainly by the power controller 110.

Next, individual components that are provided in the power unit 100 and the power controller 110 described above with reference to FIG. 1 and that perform the power control processing and the state monitoring control will be described with reference to FIG. 1.

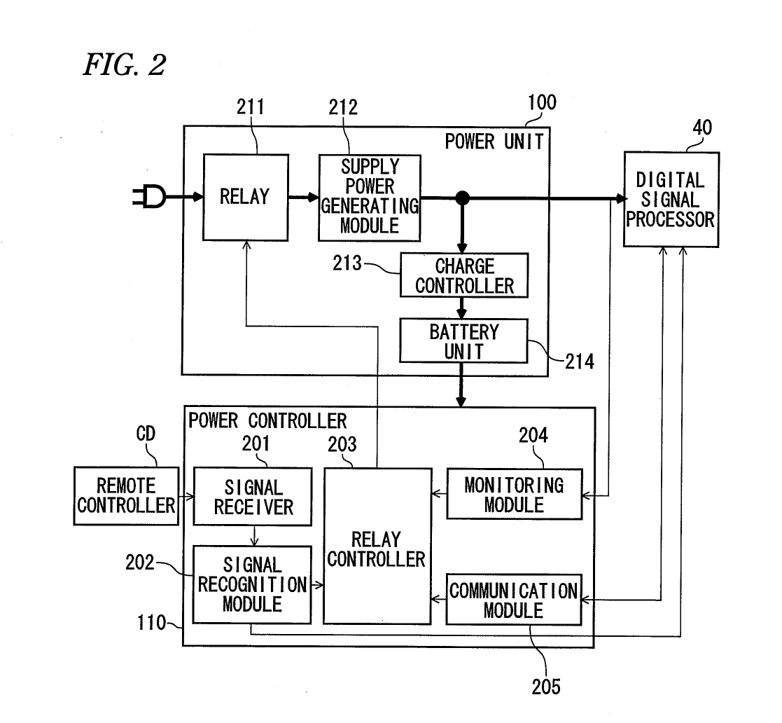

FIG. 2 is a system configuration diagram of the components which perform the power control processing and the state monitoring control according to the embodiment.

As described above, the power control processing is processing that the power controller 110 controls the power unit 100 so as to on/off-switching the supply of supply power to almost all of the components of the TV receiver 10. The state monitoring processing is processing of monitoring the actual on/off state the supply of supply power from the power unit 100.

The power unit 100 is equipped with a relay 211, a supply power generating module 212, a charge controller 213, and a battery unit 214. The power controller 110 is equipped with a signal receiver 201, a signal recognition module 202, a relay controller 203, a monitoring module 204, and a communication module 205.

The above-listed components of the power unit 100 will be described in detail.

The relay 211 is an opening/closing device having a contact for opening or closing the path from an indoor outlet to the supply power generating module 212 which supplies supply power to plural components including the digital signal processor 40. The relay 211 opens or closes its contact according to a control signal that is input from the relay controller 203 of the power controller 110, whereby the supply of supply power from the power unit 100 is on/off-switched. It is preferable that the relay 211 is disposed close to the indoor outlet (power supply source) rather than the supply power generating module 212 in the power supply path. The embodiment is directed to a case that the relay 211 is a latching relay. The latching relay is a relay which can maintain each of two states, that is, a set state that the contact is closed (power is supplied) and a reset state that the contact is open (power is not supplied), even if it is not receiving a control signal for maintaining each state. The supply power generating module 212 generates supply power having a predetermined voltage by performing voltage conversion processing such as AC/DC conversion and DC/DC conversion on power that is supplied via the relay 211. The supply power generating module 212 supplies the generated supply power to the charge controller 213 and individual components of the TV receiver 10.

While the supply of supply power is on, the charge controller 213 generates battery power by performing charging processing of charging the battery unit 214 based on supply power that is supplied from the supply power generating module 212. The charge controller 213 suspends the charging processing while the supply of supply power is off. Even while the supply of supply power is on, the charge controller 213 suspends the charging processing and supplies supply power to the battery unit 214 if the battery unit 214 is charged beyond a predetermined energy level.

The battery unit 214 is a chargeable battery that is charged by charging processing of the charge controller 21 while the supply of supply power is on and that supplies power to the individual components of the power controller 110 while the supply of supply power is off. Even while the supply of supply power is on, the battery unit 214 is not charged and operates to supply power to the individual components of the power controller 110 if the battery unit 214 is charged beyond the predetermined energy level as a result of charging processing of the charge controller 213. The battery unit 214 may be electric double layer capacitor having a predetermined capacity.

Next, the components provided in the power controller 110 will be described in detail.

The signal receiver 201 receives a signal containing information relating to a command input for manipulating the TV receiver 10 from the remote controller CD, and outputs information obtained by performing predetermined processing on the received signal to the signal recognition module 202. For example, where the remote controller CD is an infrared remote controller, the signal receiver 201 performs photoelectric conversion on an infrared signal transmitted from the remote controller CD and outputs resulting information to the signal recognition module 202. The signal receiver 201 may send the remote controller CD a signal containing information indicating a state of the TV receiver 10 that is received through a communication between the digital signal processor 40 and the communication module 205.

The signal recognition module 202 recognizes the information that is input from the signal receiver 201 and, if necessary, refers to a state of control of the relay 211 by the relay controller 203. The signal recognition module 202 outputs command corresponding to a recognition result and a reference result to the relay controller 203 or the digital signal processor 40.

More specifically, the signal recognition module 202 refers to a state of control of the relay 211 by the relay controller 203 only when it has recognized that received information is information to be used for on/off-switching the power of the TV receiver 10. In general, where the remote controller CD is a general-purpose infrared remote controller, the operation key for on/off-switching the power is a single key and hence transmitted information to be used for on/off-switching the power is also a single piece of information. The signal recognition module 202 refers to whether the relay controller 203 is controlling the relay 211 so as to close or open its contact (i.e., to turn on or off the power of the TV receiver 10). And the signal recognition module 202 outputs, to the relay controller 203 or the digital signal processor 40, switching information corresponding to a recognition result and a reference result and to be used for closing or opening the relay 211 (i.e., turning on or off the power of the TV receiver 10).

The relay controller 203 outputs, to the relay 211, a control signal to be used for on/off-switching the supply of supply power based on the received switching information that is input from the signal recognition module 202 or the communication module 205. Equipped with a timekeeping module (not shown), the relay controller 203 outputs, to the relay 211, a control signal to be used for on/off-switching the supply of supply power with predetermined timing that is managed by the timekeeping module. Furthermore, in response to reference from the signal recognition module 202, the relay controller 203 sends a response indicating whether it is controlling the relay 211 so as to close or open its contact (i.e., to turn on or off the power of the TV receiver 10). Still further, the relay controller 203 compares state information indicating an actual on/off state of the supply of supply power that is communicated from the monitoring module 204 with the information indicating whether the relay controller 203 is controlling the relay 211 so as to close or open its contact, and outputs a control signal to be used for on/off-switching the supply of supply power according to a comparison result.

The monitoring module 204 monitors the actual on/off state of the supply of supply power from the power unit 100, and informs the relay controller 203 of state information which is a monitoring result. The monitoring module 204 monitors the actual on/off state at a predetermined cycle based on a clock signal having a predetermined frequency that is generated by a clock signal generating module (not shown). The monitoring module 204 starts monitoring the actual on/off state upon a lapse of a predetermined time from a time point when the relay controller 203 output, to the relay 211, a control signal to be used for on/off-switching the supply of supply power. The monitoring module 204 monitors the actual on/off state irrespective of whether the supply of power from the power unit 100 is on or off. In the embodiment, the monitoring module 204 monitors, via an electronic circuit using resistors, a diode or transistor, etc., the voltage level of supply power that is supplied from the power unit 100 to the digital signal processor 40.

The communication module 205 communicates with a communication controller (not shown) of the digital signal processor 40 to exchange various kinds of information. In particular, when informed, by the digital signal processor 40, of information indicating that the supply of supply power is to be turned off (i.e., the contact of the relay 211 is to be opened), the communication module 205 outputs switching information corresponding to this information to the relay controller 203.

With the above system configuration, the power controller 110 according to the embodiment serves as a power control device for supply power that is supplied from the power unit 100. The power controller 110 performs not only power control processing for the supply of supply power or battery power from the power unit 100 but also state monitoring processing of monitoring the actual on/off state of the supply of supply power from the power unit 100. Since the power controller 110 performs the power control processing and the state monitoring processing in a composite manner, the stability of the supply power on/off switching control can be increased.

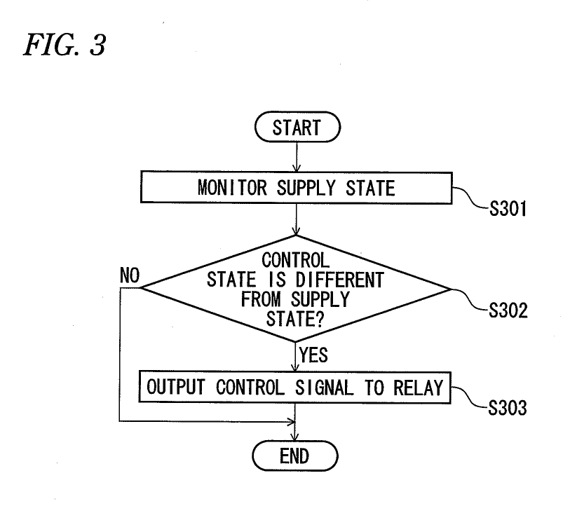

Next, the power control processing and the state monitoring processing which are performed in a composite manner by the components provided in the power controller 110 and the power unit 100 which have been described above with reference to FIG. 2 will be described with reference to FIG. 3.

FIG. 3 is a flowchart showing how the power control processing and the state monitoring processing are performed in a composite manner.

The relay controller 203 of the power controller 100 outputs, to the relay 211 of the power unit 100, a control signal to be used for on/off-switching the supply of supply power with predetermined timing or based on switching information that is input from the signal recognition module 202 or the communication module 205. The relay 211 closes or opens its contact according to the received control signal, whereby the supply of supply power from the power unit 100 is turned on or off.

At step S301, the monitoring module 204 starts monitoring the actual on/off state (supply state) of the supply of supply power from the power unit 100 upon a lapse of the predetermined time from a time point when the relay controller 203 output the control signal to the relay 211. The monitoring module 204 outputs state information as a monitoring result to the relay controller 203. At step S302, the relay controller 203 compares a supply state indicated by the state information received from the monitoring module 204 with the state of control on the relay 211 and determines whether or not the two states are different from each other.

If the supply state and the control state are the same (S302: no), the current state is maintained and the control is finished. On the other hand, if the supply state and the control state are different from each other (S302: yes), at step S303 the relay controller 203 again outputs, to the relay 211, a control signal to be used for on/off-switching the supply of supply power according to predetermined courses of action. Then, the process is finished. The above process is executed repeatedly because the monitoring module 204 monitors the actual on/off state at a predetermined cycle.

The courses of action according to which to determine whether the relay controller 203 should output a control signal to be used for turning on or off the supply of power may be one, taken arbitrarily, of the following sets of courses of action.

(1) Outputs a Control Signal that Will Cause the Same State as the Current Control State.

More specifically, the relay controller 203 outputs a control signal for turning off the supply if the supply state is “on” and the control state is “off,” and outputs a control signal for turning on the supply if the supply state is “off” and the control state is “on.”

(2) Outputs a Control Signal that Will Cause the Same State as the Current Supply State.

More specifically, the relay controller 203 outputs a control signal for turning on the supply if the supply state is “on” and the control state is “off,” and outputs a control signal for turning off the supply if the supply state is “off” and the control state is “on.”

(3) Outputs a Control Signal that Will Turn on the Supply Forcibly.

More specifically, the relay controller 203 outputs a control signal for turning on the supply irrespective of whether the supply state is “on” and the control state is “off” or the supply state is “off” and the control state is “on.”

(4) Outputs a Control Signal that Will Turn Off the Supply Forcibly.

More specifically, the relay controller 203 outputs a control signal for turning off the supply irrespective of whether the supply state is “on” and the control state is “off” or the supply state is “off” and the control state is “on.”

According to the above-described process, triggered by power control processing that the relay controller 203 outputs a control signal to the relay 211, the monitoring module 204 performs state monitoring processing. Then, the relay controller 203 performs power control processing of outputting, to the relay 211, a control signal that will equalize the supply state and the control state according to a result of the state monitoring processing. As a result, the stability of the supply power on/off switching control can be increased.

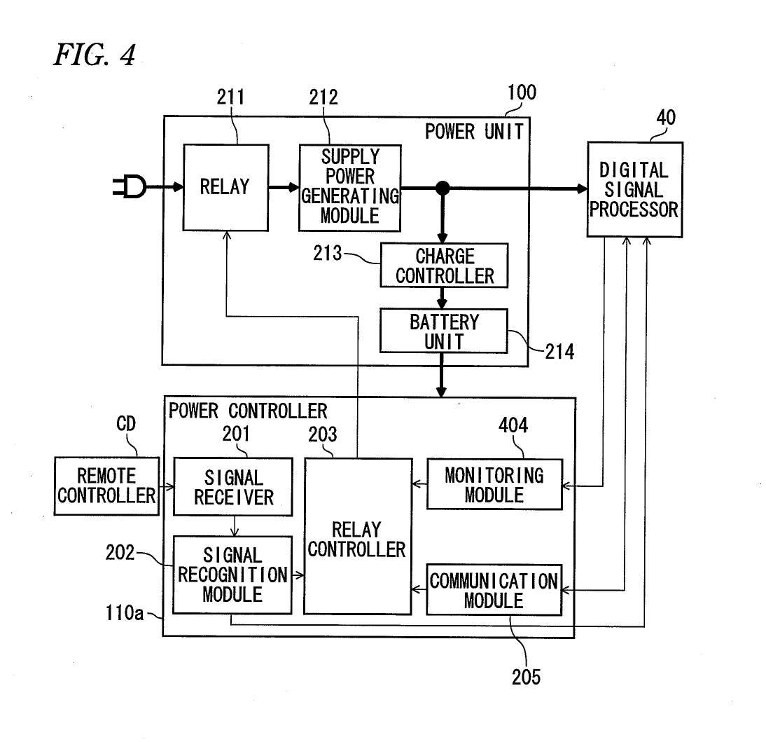

Next, modified versions of the power control processing and the state monitoring processing that are performed by the components described above with reference to FIG. 2 will be described with reference to FIG. 4.

FIG. 4 is a system configuration diagram of components which perform the modified versions of the power control processing and the state monitoring processing that are performed by the components described above with reference to FIG. 2.

The system configuration of FIG. 4 is approximately the same as that of FIG. 2 and different from the latter in the monitoring subject signal of a monitoring module 404 which is provided in a power controller 110a. Therefore, in the following, components having the same components in FIG. 2 will be given the same reference symbols as the latter and will be described briefly or will not be described at all. Only different features will be described below in detail.

The power unit 100 according to the modification is equipped with a relay 211, a supply power generating module 212, a charge controller 213, a battery unit 214, etc. The power controller 110a according to the modification is equipped with a signal receiver 201, a signal recognition module 202, a relay controller 203, the monitoring module 404, a communication module 205, etc.

The components of the power unit 100 are configured and operate in the same manners as those shown in FIG. 2.

That is, the relay 211 closes or opens its contact according to a control signal that is input from the relay controller 203, whereby the supply of supply power is turned on or off. Supply power that is obtained by the supply power generating module 212's performing predetermined voltage conversion processing on external power that is supplied from an indoor outlet via the relay 211 is supplied to almost all components of the TV receiver 10. The charge controller 213 generates battery power by performing charging processing of charging the battery unit 214 using the supply power, and supplies the supply power or battery power to the power controller 110a.

Next, the individual components of the power controller 110a will be described.

The signal receiver 201, the signal recognition module 202, the relay controller 203, and the communication module 205 are configured and operate in the same manners as those shown in FIG. 2 and hence will not be described in detail.

Whereas the monitoring module 404 is different from the monitoring module 204 shown in FIG. 2 in that the former monitors a signal that is output from the digital signal processor 40, the monitoring module 404 operates in the same manners as the monitoring module 204 in the other points. More specifically, the monitoring module 404 starts monitoring the actual on/off state of the supply of supply power irrespective of whether the supply of supply power is on or off upon a lapse of a predetermined time from a time point when the relay controller 203 output, to the relay 211, a control signal to be used for on/off-switching the supply of supply power. The monitoring module 404 thereafter continues to monitor the actual on/off state at a predetermined cycle. The monitoring module 404 outputs state information as a monitoring result to the relay controller 203. In the modification, the monitoring module 404 monitors a signal that is output from the digital signal processor 40 and has different forms depending on whether the supply of supply power is on or off. For example, the signal may be a static signal whose voltage level is kept at a level corresponding to a voltage level of a supply voltage or a clock signal having a predetermined or random cycle when the supply of supply signal is on and may be a signal whose voltage level is kept equal to the ground potential when the supply of supply signal is off.

Also in the above system configuration, the power controller 110a according to the modification is a power control device for supply power that is supplied from the power unit 100 and performs the modified versions of power control processing and state monitoring processing. In the state monitoring processing according to the modification, an arbitrary signal that enables recognition that the digital signal processor 40 is operative can be used in a state that the supply of supply power is on. Since the power controller 110a performs the modified versions of power control processing and state monitoring processing in a composite manner, the stability of the supply power on/off switching control can be increased.

As described above, in the embodiment of the invention, the TV receiver 10 performs not only the power control processing for the supply of supply power or battery power but also the state monitoring processing of monitoring the actual on/off state of the supply of supply power. Since the power control processing and the state monitoring processing are performed in a composite manner, the stability of the supply power on/off switching control can be increased.

Although the embodiments according to the present invention have been described above, the present invention may not be limited to the above-mentioned embodiments but can be variously modified. Components disclosed in the aforementioned embodiments may be combined suitably to form various modifications. For example, some of all components disclosed in the embodiments may be removed or may be appropriately combined.

Additional advantages and modifications will readily occur to those skilled in the art. Therefore, the invention in its broader aspects may not be limited to the specific details and representative embodiments shown and described herein. Accordingly, various modifications may be made without departing from the spirit or scope of the general inventive concept as defined by the appended claims and their equivalents.

What is claimed is:

1. A power control device comprising:
a controller configured to control a power supplied to other components by switching the power on or off;
a monitoring module configured to monitor a supply state of the power, the supply state indicating an actual on/off state of the power; and
a comparing module configured to compare a control state of the power controlled by the controller and the supply state,
wherein the controller is configured to control the power so as to equalize the control state and the supply state when a comparison result of the comparing module shows that the control state and the supply state are different from each other.

2. The device of claim 1,
wherein the controller is configured to control the power based on one of the control state and the supply state, when the comparison result of the comparing module shows that the control state and the supply state are different from each other.

3. The device of claim 1,
wherein the controller is configured to control the power so as to forcibly turn the power on or off, when the comparison result of the comparing module shows that the control state and the supply state are different from each other.

4. The device of claim 1,
wherein the monitoring module is configured to monitor at least one of a voltage level of the power and an operation state of the components to which the power is supplied.

5. An electronic apparatus comprising:
a signal processor configured to operate by being supplied with power;
a controller configured to control the power supplied to the signal processor by switching the power on or off;
a monitoring module configured to monitor a supply state of the power indicating an actual on/off state of the power; and
a comparing module configured to compare a control state of the power controlled by the controller and the power supply state monitored by the monitoring module,
wherein the controller is configured to control the power so as to equalize the control state and the supply state, when a comparison result of the comparing module shows that the control state and the supply state are different from each other.

6. A power control method comprising:
controlling power supplied to other components by switching the power on or off;
monitoring a supply state indicating an actual on/off state of the power;
comparing a control state of the power and the monitored supply state; and
controlling the power so as to equalize the control state and the supply state when a comparison result shows that the control state and the supply state are different from each other.
